(19) United States
(12) Patent Application Publication
(10) Pub. No.: US 2006/0130062 A1
(43) Pub. Date: Jun. 15, 2006

(54) Scheduling threads in a multi-threaded computer

(75) Inventors: Dean Joseph Burdick, Austin, TX (US); Bret Ronald Olszewski, Austin, TX (US)

Correspondence Address: INTERNATIONAL CORP (BLF), c/o BIGGERS & OHANIAN, LLP, P.O. BOX 1469, AUSTIN, TX, 78767-1469, US

(73) Assignee: INTERNATIONAL BUSINESS MACHINES CORPORATION, ARMONK, NY (US)

(21) Appl. No.: 11/011,248

(22) Filed: Dec. 14, 2004

(51) Int. Cl. G06F 9/46

(52) U.S. Cl. 718/100

(57) ABSTRACT

Scheduling threads in a multi-threaded computer including selecting for awakening a thread that is waiting for a lock, the thread having an assigned virtual processor; determining whether the assigned virtual processor is running; and if the assigned virtual processor is not running, assigning the thread to run on another virtual processor. Selecting a thread may include selecting the thread according to thread priority or selecting the thread according to sequence of thread arrival in a wait queue. Selecting a thread may include selecting a thread having an assigned virtual processor that is running. Selecting a thread may include selecting a thread having an assigned virtual processor that is running and has at least a predetermined amount of time remaining in its current time slice.

### BACKGROUND OF THE INVENTION

1. Field of the Invention

The field of the invention is data processing, or, more specifically, methods, systems, and products for scheduling threads in a multi-threaded computer.

2. Description of Related Art

A thread is a unit of software execution on a multi-threaded computer. That is, a thread is an executable entity of work in a computer system. A thread can be viewed of as a separate stream of executable computer program instructions. On such a computer, software programs are executed in units of execution called ‘processes’ that include all the processor registers, code segment and offset registers, data segment and offset registers, stack segment and offset registers, flag registers, instruction pointer registers, program counters, and so on, needed for execution of software programs. For efficiency, ‘processes’ are organized further as threads, where each thread of a process individually possesses all the attributes needed for execution except that a thread shares memory among all the other threads of a process, thereby reducing the overhead of operating system switches from thread to thread (‘context switches’).

A ready queue contains all the threads of the system that are in the ‘ready’ state, waiting in priority order for dispatching to a processor. Threads are placed in the ready queue when they are first created and from a wait queue upon returns from system calls. When dispatched to a processor, each thread is typically authorized to occupy the processor for no more than a maximum amount of time referred to as a ‘time slice,’ after which the thread is said to be ‘preempted’ for return to the ready queue until other threads have a chance to run on the processor. Threads are also typically placed on the ready queue when they are preempted while running on a processor; that is, when a higher priority thread arrives in the ready queue or when a thread's time slice expires.

‘Scheduling’ is the overall process of determining which thread will run on each processor and the order or sequence in which the threads are run. ‘Dispatching’ is the process of changing a thread from ready state to run state. Assigning a thread to run on a particular virtual processor therefore is usefully considered part of the overall process of scheduling.

Threads of a process share the same memory space and are capable of reading and writing to the same memory addresses. Moreover, a thread reading a memory address may suffer an interrupt between any two computer program instructions, and there is no guarantee that a processor will regain run status before another thread writes to the same memory address. Such a situation is called a ‘race condition.’ A race condition can occur when more than one thread can simultaneously access shared memory, and the threads can both read and modify the data in memory. A common way to prevent race conditions is called ‘mutual exclusion’ or ‘mutex.’ In mutual exclusions, portions of code where shared data are read or modified are defined as ‘critical sections,’ and some mechanism is implemented to guarantee that two threads will never be in a critical section for the same shared data at the same time.

A mechanism that guarantees that two threads will never be in a critical section for the same shared data at the same time is referred to in this specification as a ‘lock.’ Examples of locks include Unix semaphores, monitor classes in C++, and synchronized methods in Java. A thread that requests exclusive access to a critical section for shared data is said to request a lock; requesting a lock is typically implemented with a system call which, if the lock is not immediately available, places the requesting thread in wait state until the lock becomes available. A thread that has exclusive access to a critical section for shared data is said to hold the lock.

Two modes of multi-threading are discussed in this specification: simultaneous multi-threading (‘SMT’) and single-threaded (‘ST’) multi-threading. ST multi-threading is time-multiplexed multi-threading, that is, multi-threading by use of time slices or time quanta. In ST mode, both individual threads and virtual processors are assigned to a portion of a processor's computing capacity apportioned in segments of time, each of which is referred to as a ‘time slice’ or ‘time quantum.’

Some processors accept computer program instructions from more than one thread simultaneously, a feature referred to as ‘simultaneous multi-threading’ or ‘SMT.’ The idea behind SMT is to share the processor hardware on a chip among multiple threads of a multi-threaded workload. SMT is a technique that lets multiple independent threads issue instructions to a single physical processor in a single processing cycle. Traditional processor architectures issue instructions to a processor from only one thread at a time. An example of a processor that implements SMT as described here is IBM's Power5™ processor.

SMT is implemented on physical processors each of which is capable of accepting instructions from more than one thread of execution simultaneously. Also in SMT mode, both virtual processors and threads running on virtual processors may be apportioned through time slices. A thread of execution on a virtual processor in SMT mode may be viewed as running on a logical processor. A virtual processor running on a physical processor in SMT mode therefore may be viewed as supporting more than one logical processor.

In a computer that supports ST multi-threading as well as SMT, administration of threads may be carried out in a traditional way by an operating system operating in a logical partition in which logical processors in SMT mode and virtual processors in ST mode all are viewed from the point of view of the operating system as a traditional processor. A thread running on a logical processor or a virtual processor is unaware of the logical or virtual nature of the processor and views it as a traditional processor.

Locks are amenable to convoy effects. Only one thread at a time can gain possession of a lock. A convoy occurs when a number of threads request access to the same lock. All requesting threads may experience context switches from run state to wait state. They may leave wait state, return to ready state, compete for possession of a processor, again request the lock, and, if it is not available, again return to wait state—to start the whole process all over again. The traditional remedy is to minimize the size of critical sections of computer program instructions, so that a lock-holder only retains the lock for the minimum amount of time necessary to carry out the pertinent data processing. This is not a complete solution, however, and, when convoy effects occur, they are particularly detrimental to overall computer system performance.

### SUMMARY OF THE INVENTION

Methods, systems, and computer program products are described that reduce the risk of convoy effects by improving the overall efficiency of utilization of thread time on virtual processors by, for example, re-assigning awakened threads to virtual processors that are currently running and by increasing the time slices of virtual processors upon which lock-holding threads are running. More particularly, methods, systems, and products are described for scheduling threads in a multi-threaded computer that include selecting for awakening a thread that is waiting for a lock, the thread having an assigned virtual processor; determining whether the assigned virtual processor is running; and if the assigned virtual processor is not running, assigning the thread to run on another virtual processor.

Selecting a thread may include selecting the thread according to thread priority or selecting the thread according to sequence of thread arrival in a wait queue. Selecting a thread may include selecting a thread having an assigned virtual processor that is running. Selecting a thread may include selecting a thread having an assigned virtual processor that is running and has at least a predetermined amount of time remaining in its current time slice.

Methods, systems, and products for scheduling threads in a multi-threaded computer may include a thread's requesting a lock and entering wait state during a time quantum of the assigned virtual processor wherein the assigned virtual processor has no threads in ready state; the assigned virtual processor's leaving run state, including leaving an unused portion of the time quantum of the assigned virtual processor; and increasing, by the unused portion of the time quantum of the assigned virtual processor, the time quantum of a virtual processor of a thread holding the lock.

Methods, systems, and products for scheduling threads in a multi-threaded computer may include an assigned virtual processor's running in simultaneous multi-threading (‘SMT’) mode with two active SMT threads including a thread's requesting a lock and entering wait state during a time quantum of the assigned virtual processor; removing the assigned virtual processor from run state, regardless whether the second thread is still running and regardless whether the assigned virtual processor has threads in ready state, including leaving an unused portion of a time quantum of the assigned virtual processor; and increasing the time quantum of a virtual processor of a thread holding the lock by the unused portion of the time quantum of the assigned virtual processor.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

For further explanation, therefore, FIG. 1 sets forth a block diagram of automated computing machinery comprising an exemplary computer useful in scheduling threads in a multi-threaded computer according to embodiments of the present invention.

FIG. 2 sets forth a functional block diagram illustrating an exemplary system for scheduling threads in a multi-threaded computer according to embodiments of the present invention.

FIG. 3A sets forth a state diagram illustrating exemplary thread states for scheduling threads in a multi-threaded computer according to embodiments of the present invention.

FIG. 3B sets forth a state diagram illustrating exemplary virtual processor states for scheduling virtual processors in a multi-threaded computer according to embodiments of the present invention.

FIG. 4 sets forth a flow chart illustrating an exemplary method for scheduling threads in a multi-threaded computer according to embodiments of the present invention.

FIG. 5 sets forth a flow chart illustrating a further exemplary method for scheduling threads in a multi-threaded computer according to embodiments of the present invention.

FIG. 6 sets forth a flow chart illustrating a further exemplary method for scheduling threads in a multi-threaded computer according to embodiments of the present invention.

FIG. 7 sets forth a flow chart illustrating a further exemplary method for scheduling threads in a multi-threaded computer according to embodiments of the present invention.

### DETAILED DESCRIPTION OF EXEMPLARY EMBODIMENTS

### Introduction

The present invention is described to a large extent in this specification in terms of methods for scheduling threads in a multi-threaded computer. Persons skilled in the art, however, will recognize that any computer system that includes suitable programming means for operating in accordance with the disclosed methods also falls well within the scope of the present invention. Suitable programming means include any means for directing a computer system to execute the steps of the method of the invention, including for example, systems comprised of processing units and arithmetic-logic circuits coupled to computer memory, which systems have the capability of storing in computer memory, which computer memory includes electronic circuits configured to store data and program instructions, programmed steps of the method of the invention for execution by a processing unit.

The invention also may be embodied in a computer program product, such as a diskette or other recording medium, for use with any suitable data processing system. Embodiments of a computer program product may be implemented by use of any recording medium for machine-readable information, including magnetic media, optical media, or other suitable media. Persons skilled in the art will immediately recognize that any computer system having suitable programming means will be capable of executing the steps of the method of the invention as embodied in a program product. Persons skilled in the art will recognize immediately that, although most of the exemplary embodiments described in this specification are oriented to software installed and executing on computer hardware, nevertheless, alternative embodiments implemented as firmware or as hardware are well within the scope of the present invention.

### Scheduling Threads in a Multi-Threaded Computer

Exemplary methods, systems, and products for scheduling threads in a multi-threaded computer according to embodiments of the present invention are described with reference to the accompanying drawings, beginning with FIG. 1. Scheduling threads in a multi-threaded computer in accordance with the present invention is implemented upon automated computing machinery, that is, on one or more computers. For further explanation, therefore, FIG. 1 sets forth a block diagram of automated computing machinery comprising an exemplary computer (152) useful in scheduling threads in a multi-threaded computer according to embodiments of the present invention. The computer (152) of FIG. 1 includes several physical processors (130, 132, 156) as well as random access memory (“RAM”) (168) which is connected through a system bus (160) to the physical processors and to other components of the computer.

Stored in RAM (168) is a logical partition (102), a virtual processor (122), an operating system (154), a logical processor (106), and a hypervisor (118). A logical partition (‘LPAR’) (102) is a set of data structures and services that enables distribution of computer resources within a single computer to make the computer function as if it were two or more independent computers. Each logical partition is assigned all the resources it needs to operate as though it were an independent computer including, processor time, memory, an operating system, and so on.

A virtual processor (122) is a subsystem, data structures and computer program instructions, that implements assignment of processor time to a logical partition. A shared pool of physical processors supports the assignment of partial physical processors (in time slices) to a logical partition. Such partial physical processors shared in time slices are referred to as ‘virtual processors.’ Physical processors held in a shared processing pool are shared among logical partitions. In the examples in this specification, physical processors are shared according to processing units with 1.0 processing units representing the processing capacity of one physical processor.

An operating system (154) is a layer of system software that schedules threads and provides functions for making system resources available to threads, including memory access, access to input/output resources, and so on. Operating systems also control allocation and authorization for access to computer resources. Operating systems low-level, basic tasks, such as recognizing input from a keyboard, sending output to a display screen, keeping track of files and directories on a magnetic disk drive, and controlling peripheral devices such as disk drives and printers. The operating system is also responsible for security, ensuring that unauthorized users do not access the system and that threads access only resources they are authorized to access. Operating systems useful for scheduling threads in a multi-threaded computer according to embodiments of the present invention are multi-threading operating systems, examples of which include UNIX™, Linux™, Microsoft NT™, AIX™, IBM's i5os, and many others as will occur to those of skill in the art.

In the example of FIG. 1, operating system (154) includes computer program instructions capable of scheduling threads in a multi-threaded computer according to embodiments of the present invention including selecting for awakening a thread that is waiting for a lock (where the thread has an assigned virtual processor), determining whether the assigned virtual processor is running, and assigning the thread to run on another virtual processor if the assigned virtual processor is not running. Assigning a thread to run on a virtual processor is typically carried out by assigning the thread to run on a logical processor of a virtual processor. In ST mode, each virtual processor has one logical processor.

In SMT mode, however, each virtual processor has two logical processors. In SMT mode, therefore, it is not enough to move the thread to any other logical processor—because one of the other logical processors is one of the two logical processors of the currently assigned virtual processor—and moving to that processor would not result in an assignment to another virtual processor. In SMT mode, therefore, assigning the thread to run on another virtual processor is carried out by reassigning the thread to a logical processor of a virtual processor other than the assigned virtual processor.

A logical processor (106) is an operating system's structure for scheduling threads for execution. That is, rather than scheduling threads for execution on a physical processor or a virtual processor, operating system (154) schedules threads for execution on a logical processor (106). Scheduling a thread on a logical processor provides convenient structure and processing in which the thread appears, from the point of view of the thread, to have at its disposal all the resources of an entire LPAR. Virtual processors are apportioned fractions of a physical processor. A logical processor, however, is logically an entire processor—despite the fact that it is physically running in a fractional time slice just like all other execution on the machine. A thread running on a logical processor in an LPAR appears, therefore, from its point of view, to have all the resources of an entire independent computer. That is, the logical processor is the object upon which the dispatcher in the an operating system running in a partition threads (looking from operating system down), and a virtual processor is what is dispatched by the hypervisor. n an LPAR operating in ST mode, the correspondence between logical processors and virtual processors is one-to-one, one logical processor for each virtual processor. In an LPAR operating in SMT mode, the correspondence between logical processors and virtual processors is N-to-one, where N is the number of logical processors supported on a virtual processor, that is, N logical processors for each virtual processor.

The hypervisor (118) of FIG. 1 is a layer of system software that runs under operating systems in logical partitions. That is, a hypervisor (118) runs between an operating system and underlying physical computer components—including physical processors. It is the function of the hypervisor, among other things, is to schedule virtual processors on physical processors.

In the example of FIG. 1, hypervisor (118) includes computer program instructions capable of scheduling threads in a multi-threaded computer according to embodiments of the present invention that include increasing, by an unused portion of a time quantum of an assigned virtual processor, the time quantum of a virtual processor of a thread holding a lock. This may occur when a thread requests a lock and enters wait state during a time quantum of the thread's assigned virtual processor, when, for example, the assigned virtual processor has no threads in ready state. This may occur in ST mode, for example, when the logical processor upon which the thread is running when it requests the lock has no threads queued in its ready queue. In this example, because the logical processor and its virtual processor have no need for the remainder of the current time slice, the assigned virtual processor's leaves run state, which also leaves an unused portion (616) of the time quantum (604) of the assigned virtual processor (602). The hypervisor then adds the unused portion of the time quantum of the assigned virtual processor to the time quantum of the virtual processor holding the lock—thereby increasing the likelihood that the thread holding the lock will complete its critical section and release the lock during its current time slice.

Alternatively in the example of FIG. 1, hypervisor (118) may include computer program instructions capable of scheduling threads in a multi-threaded computer according to embodiments of the present invention that include increasing the time quantum of a virtual processor of a thread holding the lock by the unused portion of the time quantum of the assigned virtual processor where the assigned virtual processor is running in SMT mode with two active SMT threads including a first thread that requests a lock and a second thread. This may occur when the first thread requests a lock and enters wait state during a time quantum of the thread's assigned virtual processor. Ordinarily the virtual processor would only leave the run state, relinquishing the physical processor and giving up the remainder of its time slice, when both threads have voluntarily given up control, that is, when each SMT thread (or logical processor) has exited all threads running on it and there are no threads in ready state for either logical processor. In this example, however, the hypervisor is programmed to forcibly remove the assigned virtual processor from run state, regardless whether the second thread is still running and regardless whether the assigned virtual processor has threads in ready state. This again leaves an unused portion of a time quantum of the assigned virtual processor. The hypervisor is programmed to then add the unused portion of the time quantum of the assigned virtual processor to the time quantum of the virtual processor holding the lock.

Hypervisor (118), virtual processor (122), logical partition (102), operating system (154), and logical processor (106) in the example of FIG. 1 are shown in RAM (168). Readers of skill in the art, however, will recognize that many components of such software may be stored in non-volatile memory (166) also. Computer (152) of FIG. 1 includes non-volatile computer memory (166) coupled through a system bus (160) to processor (156) and to other components of the computer (152). Non-volatile computer memory (166) may be implemented as a hard disk drive (170), optical disk drive (172), electrically erasable programmable read-only memory space (so-called ‘EEPROM’ or ‘Flash’ memory) (174), RAM drives (not shown), or as any other kind of computer memory as will occur to those of skill in the art.

The example computer of FIG. 1 includes one or more input/output interface adapters (178). Input/output interface adapters in computers implement user-oriented input/output through, for example, software drivers and computer hardware for controlling output to display devices (180) such as computer display screens, as well as user input from user input devices (181) such as keyboards and mice.

The exemplary computer (152) of FIG. 1 includes a communications adapter (167) for implementing data communications with other computers. Such data communications may be carried out, for example, through data communications networks such as IP networks—and in other ways as will occur to those of skill in the art. Communications adapters implement the hardware level of data communications through which one computer sends data communications to another computer, directly or through a network. Examples of communications adapters useful for determining availability of a destination according to embodiments of the present invention include modems for wired dial-up communications, Ethernet (IEEE 802.3) adapters for wired network communications, and 802.11b adapters for wireless network communications.

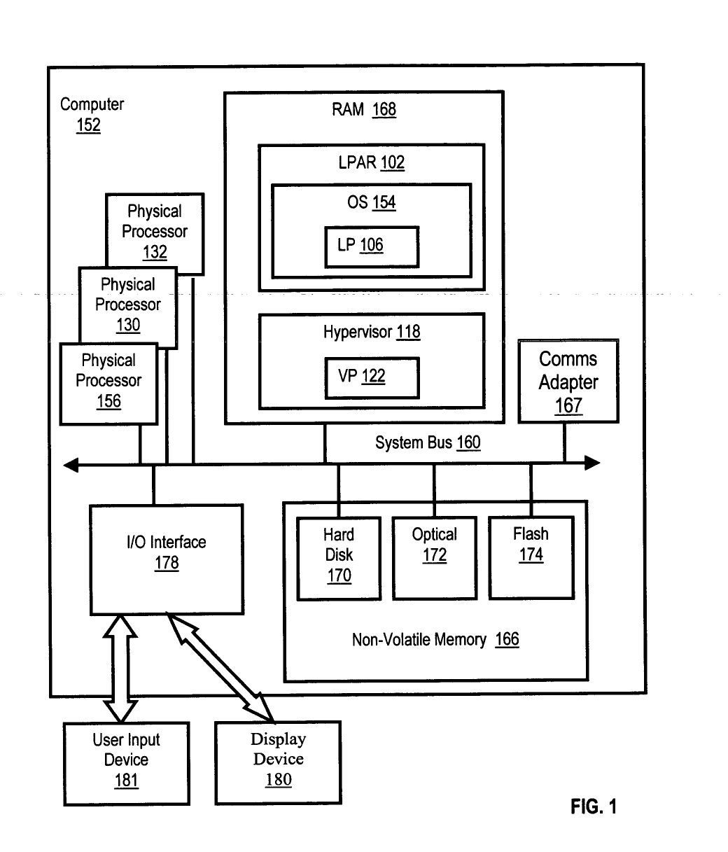

For further explanation, FIG. 2 sets forth a functional block diagram illustrating an exemplary system for scheduling threads in a multi-threaded computer according to embodiments of the present invention. The system of FIG. 2 includes two LPARs, one in ST mode (102) and one in SMT mode (104). The system of FIG. 2 includes two operating systems (154, 155), one each in LPAR (102) and LPAR (104) respectively. In this example, the operating systems (154, 155) each include computer program instructions capable of scheduling threads in a multi-threaded computer according to embodiments of the present invention including selecting for awakening a thread that is waiting for a lock (where the thread has an assigned virtual processor), determining whether the assigned virtual processor is running, and assigning the thread to run on another virtual processor if the assigned virtual processor is not running.

The system of FIG. 2 includes six logical processors, two for operating system (154) in LPAR (102) and four for operating system (155) in LPAR (104). Each logical processor has a ready queue (134) where each thread in ready state remains until it is dispatched to run state. Each logical processor also has a wait queue (136) where sleeping threads wait for locks to be released—and for other returns from system calls.

The system of FIG. 2 includes a hypervisor (118) and four virtual processors, two (122, 124) assigned to LPAR (102) and two (126, 128) assigned to LPAR (104). In the example of FIG. 2, hypervisor (118) includes computer program instructions capable of scheduling threads in a multi-threaded computer according to embodiments of the present invention that include increasing, by an unused portion of a time quantum of an assigned virtual processor, the time quantum of a virtual processor of a thread holding a lock.

The system of FIG. 2 also includes three physical processors (156, 130, 132). Each physical processor has a ready queue (140) where each virtual processor in ready state remains until it is dispatched to run state. Each physical processor also has a wait queue (138) where sleeping virtual processors wait for returns from hypervisor calls. In this example, the processing capacity of the three physical processors (156, 130, 132) is apportioned to the LPARs as follows:
All of the processing capacity of physical processor (156) is assigned entirely to virtual processor (122), so that logical processor (106) has available to it the entirety of physical processor (156).
One-half the processing capacity of physical processor (130) is assigned to virtual processor (124), so that logical processor (108) has available to it in time slices one-half of physical processor (130).
One-half the processing capacity of physical processor (130) is assigned to virtual processor (126). Virtual processor (126) is assigned to LPAR (104) which runs in SMT mode with two logical processors (110, 112) for virtual processor (126). Logical processor (110) and logical processor (112) each has available to it in time slices one-fourth of the processing capacity of physical processor (130).
All of the processing capacity of physical processor (132) is assigned to virtual processor (128). Virtual processor (128) is assigned to LPAR (104) which runs in SMT mode with two logical processors (114, 116) for virtual processor (128). Logical processor (114) and logical processor (116) each has available to it in time slices one-half of the processing capacity of physical processor (132).

The example of FIG. 2 illustrates that virtual processors assigned to an operating system in a logical partition represent the whole number of concurrent operations which an operating system can utilize. Data processing capacity of a computer may be viewed as being apportioned across such virtual processors. For a further example, consider a system with four physical processors in a shared pool that may be viewed as providing 4.00 processing units—where each physical processor is viewed as providing one processing unit. Five LPARs may then distribute the processing capacity of such a computer as follows:
Partition 0 having 2.00 processing units and 2 virtual processors;
partition 1 having 0.50 processing units and 1 virtual processor;
partition 2 having 0.50 processing units and 1 virtual processor;
partition 3 having 0.75 processing units and 1 virtual processor; and
partition 4 having 0.25 processing units and 1 virtual processor.

In this example, the sum of the 5 logical partitions' processing units is less than or equal to the total number of processing units in the shared pool, and the total number of virtual processors is 6.

Shared processor capacity in these examples is delivered in terms of whole physical processors. Virtual processors in ST mode have one logical processor each. Virtual processors in SMT mode each have one two processors because each represents two simultaneous threads of execution on an underlying physical processor. For a still further example therefore, consider an LPAR with virtual processors running in ST mode and entitled to 2.00 units of processor capacity. This example LPAR is configured as four virtual processors where each virtual processor has one-half the processing capacity of a physical processor. When the virtual processors in the same LPAR are switched to SMT mode with two logical processor per virtual processor, it becomes an 8-way LPAR, where each of eight logical processors has approximately one-fourth of the processing capacity of a physical processor.

These latter examples also help to illustrate the fact that the number, arrangement, and assignments of physical processors, virtual processors, and logical processors in the system of FIG. 2 is for explanation only, not for a limitation of the present invention. A multi-threaded computer system that schedules threads according to embodiments of the present invention may include any number, arrangement, or assignment of physical processors, virtual processors, and logical processors.

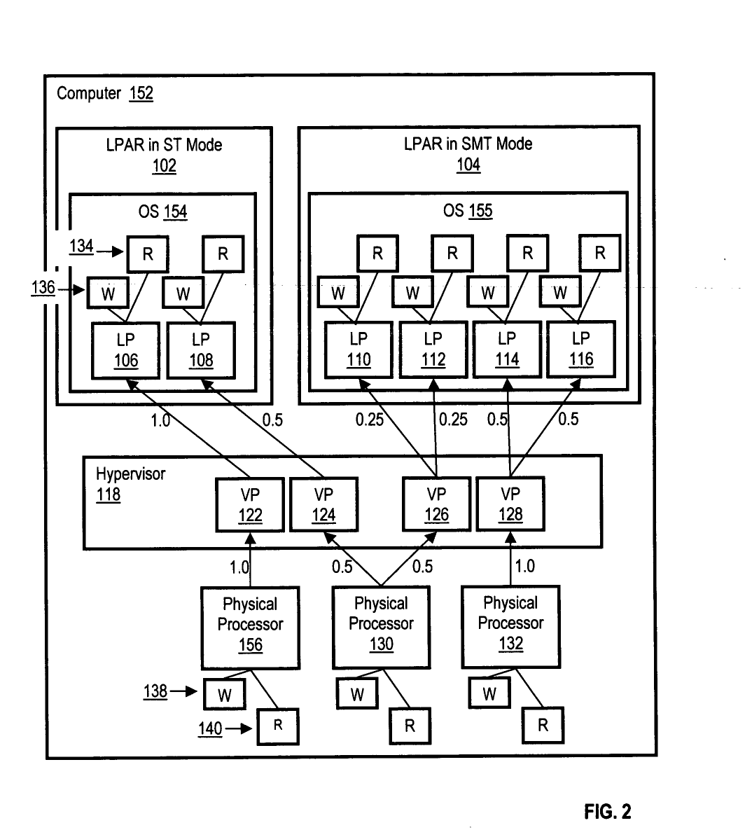

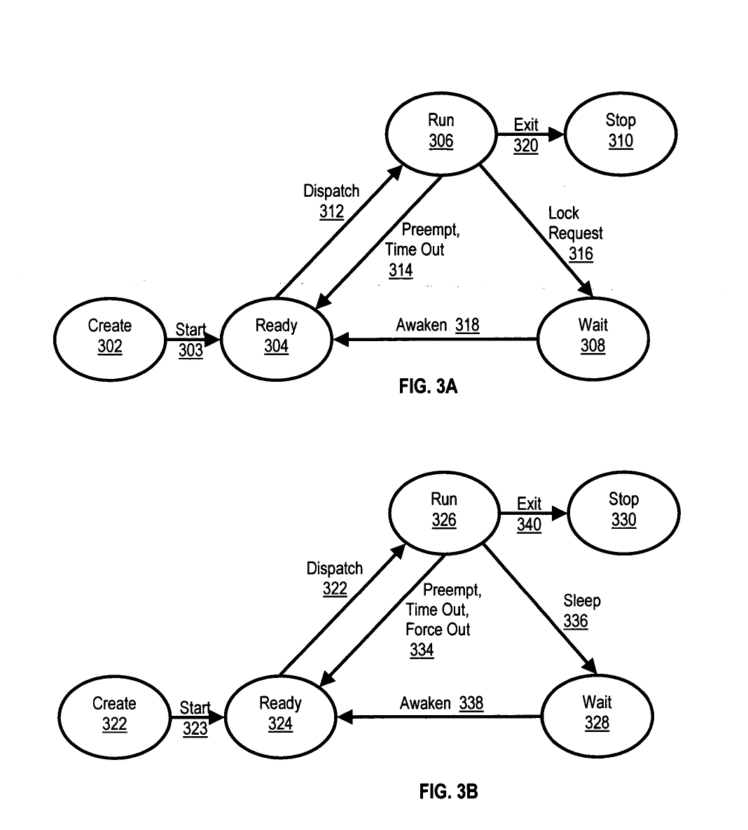

For further explanation, FIG. 3A sets forth a state diagram illustrating exemplary thread states for scheduling threads in a multi-threaded computer according to embodiments of the present invention. The bubbles in FIG. 3A represent thread states. The arrows between the bubbles represent state transitions effected by operating system functions. The thread states represented in FIG. 3A include a create state (302), a ready state (304), a run state (306), a wait state (308), and a stop state (310). A thread resides temporarily in the create state (302) when the thread is first created at the request of another thread, to give the operating system time to gather information and resources for the thread. As soon as the operating system prepares the thread to run, it is ‘started’ (303), that is, moved to the ready state (304).

Threads in the ready state (304) are queued, in a ‘ready queue,’ waiting for an opportunity to run. The process of determining which ready thread will run next is called ‘scheduling.’ There are many scheduling algorithms, FIFO, Round Robin, Priority, and so on, and any of them may be used in system for scheduling threads according to embodiments of the present invention. The operating system function for moving a thread from ready state to run state is called dispatching (312). In fact, ‘dispatched,’ ‘running,’ and ‘in run state,’ are generally synonymous.

When a thread is dispatched, that is, in run state (306), the thread is presently assigned to execute on a logical processor. Whether the thread is physically executing depends on whether the logical processor's virtual processor is currently dispatched through its hypervisor, that is, currently executing in a time slice on a physical processor. A ready queue for a logical processor may contain one, two, or more threads in ready state waiting to run on the logical processor. Only one thread at a time is placed in run state on a logical processor.

Threads can lose possession of the logical processor, be removed from run state to ready state, by preemption or time out (314). A thread is preempted when a thread having a higher priority enters the ready queue for the logical processor. A thread times out if it retains in possession of the logical processor, that is, remains in run state, through its entire time slice.

A thread also may leave run state (306) by issuing a system call and entering wait state (308)—to wait for completion of the system call. Such system calls include intentional requests to sleep or wait for a certain period of time, requests for data to be read from or written to disk, requests for data to be read from or written to input/output resources, and so on. In particular, in this example, such system calls include lock requests (316).

In this example, when a requested lock is released by a lock holder and a thread is returned to ready state to eventually return to run state and pursue its request for the lock, the process of returning the thread from wait state to ready state is referred to as awakening (318) the thread. In such a system, more than one thread may be queued in wait state waiting for the same lock. In the example of FIG. 3A, an operating system function that awakens threads waiting for a lock includes computer program instructions capable of selecting for awakening a thread that is waiting for a lock (where the thread has an assigned virtual processor), determining whether the assigned virtual processor is running, and assigning the thread to run on another virtual processor if the assigned virtual processor is not running.

For further explanation, FIG. 3B sets forth a state diagram illustrating exemplary virtual processor states for scheduling virtual processors in a multi-threaded computer according to embodiments of the present invention. The bubbles in FIG. 3B represent virtual processor states. The arrows between the bubbles represent state transitions effected by hypervisor functions. The virtual processor states represented in FIG. 3B include a create state (322), a ready state (324), a run state (326), a wait state (328), and a stop state (330). A virtual processor resides temporarily in the create state (322) when the virtual processor is first created, typically at boot time, to give the hypervisor time to gather information and resources for the virtual processor. As soon as the hypervisor prepares the virtual processor to run, the virtual processor is ‘started’ (323), that is, moved to the ready state (324).

Virtual processors in the ready state (324) are queued, in a ‘ready queue,’ waiting for an opportunity to run. A hypervisor schedules virtual processors to run, according to one or more scheduling algorithms, Round Robin, Priority, and so on. The hypervisor dispatches (322) from the ready state to the run state the single virtual processor from the ready queue presently most qualified for actual possession of the physical processor to which the virtual processor is assigned. Only one virtual processor at a time is placed in run state on a physical processor.

In the example of FIG. 3B, the hypervisor that moves virtual processors among the virtual processor states includes computer program instructions capable of scheduling threads in a multi-threaded computer according to embodiments of the present invention that include increasing, by an unused portion of a time quantum of an assigned virtual processor, the time quantum of a virtual processor of a thread holding a lock. Each virtual processor dispatched to run state retains current possession of a physical processor for a maximum amount of time specified as a time slice for the virtual processor. The time slice typically is identified as a portion of the processing capacity of the physical processor, but it is specified as a certain period of time. If a running thread holds a lock requested by another thread, and the requesting thread's virtual processor surrenders its physical processor before the end of its time slice, the hypervisor advantageously increases the time slice of the virtual processor of the running lock holder by the unused portion of the time slice of the virtual processor of the requesting thread—in effect, transferring the balance of the waiting virtual processor to the still running virtual processor of the lock holder. This process gives the lock holder a greater chance of completing its critical section before its virtual processor times out, reducing the risk of convoy effects among threads waiting for the lock.

In effect the preceding paragraph describes a voluntary surrender of a physical processor by a virtual processor that may occur in at least two circumstances:
The virtual processor runs in ST mode with one logical processor, a thread running on the logical processor requests a lock, and there are no threads remaining in ready state for the logical processor; or
The virtual processor runs in SMT mode with two logical processors, a thread running on one of its logical processors requests a lock, the thread running on the other logical processor has voluntarily surrendered the other logical processor, and there are no threads remain in ready state for either logical processor.

Virtual processors can lose possession of the physical processor and be removed from run state to ready state, by preemption, time out, or by being forced out (334). A virtual processor is preempted when a virtual processor having a higher priority enters the ready queue for the physical processor. A virtual processor times out if it retains possession of the physical processor, that is, remains in run state, through its entire time slice.

In the example of FIG. 3B, a hypervisor may force a virtual processor out of the run state, returning it to the ready state where it must again compete for the possession of the physical processor with other virtual processors in the ready state according to the scheduling rules of the hypervisor. The hypervisor, as mentioned above, may include a capability of increasing the time quantum of a virtual processor of a thread holding a lock by the unused portion of the time quantum of an assigned virtual processor where the assigned virtual processor is running in SMT mode with two active SMT threads including a first thread that requests a lock and a second thread. This may occur when the first thread requests a lock and enters wait state during a time quantum of the thread's assigned virtual processor. Ordinarily the virtual processor would only leave the run state, relinquishing the physical processor and giving up the remainder of its time slice, when both threads have voluntarily given up control, that is, when each SMT thread (or logical processor) has exited all threads running on it and there are no threads in ready state for either logical processor. In this example, however, the hypervisor is programmed to forcibly remove (334) the assigned virtual processor from run state, regardless whether the second thread is still running and regardless whether the assigned virtual processor has threads in ready state. This leaves an unused portion of a time quantum of the assigned virtual processor. The hypervisor adds the unused portion of the time quantum of the assigned virtual processor to the time quantum of the virtual processor holding the lock.

A virtual processor also may leave run state (326) by issuing a system call and entering wait state (328)—to wait for completion of the system call. Such system calls include intentional requests to sleep or wait for a certain period of time, requests for data to be read from or written to disk, requests for data to be read from or written to input/output resources, and so on. When a thread running on a virtual processor, that is, running on a single logical processor of a virtual thread in ST mode, issues a system call to wait for keyboard input or for release of a lock, for example, the virtual processor may determine that there is no need for the virtual processor to continue to occupy the physical processor merely to do nothing until a keystroke arrives or until the thread holding the lock releases it. In this circumstance, the virtual processor may put itself to sleep (336) for a certain period off time, a tenth of a second for example. Returning the virtual processor from wait state to ready state is referred to as awakening (338) the virtual processor.

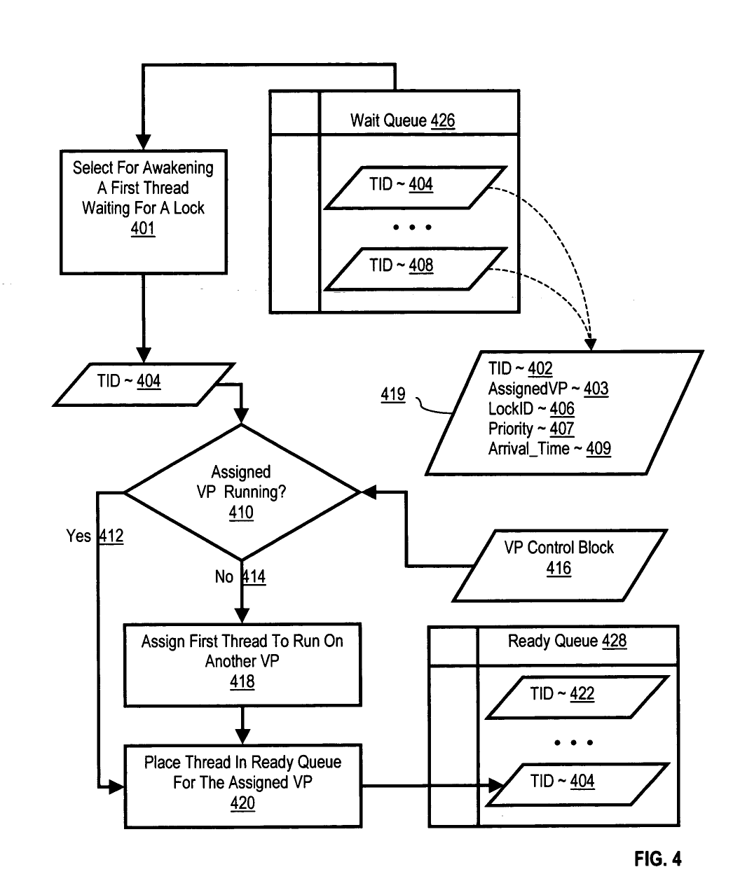

For further explanation, FIG. 4 sets forth a flow chart illustrating an exemplary method for scheduling threads in a multi-threaded computer according to embodiments of the present invention that includes selecting (401) for awakening a thread (404) that is waiting for a lock. In the example of FIG. 4, threads are represented by data structures (419, 408), and each thread has an assigned virtual processor. Threads waiting for a lock are in a wait queue (426), and selecting a thread for awakening includes selecting one of the threads waiting for a lock in a wait queue.

FIG. 4 includes a more detailed example of a data structure (406) for representing a thread in a wait queue. Data structure (406) includes:
a thread identification field named TID (402) for storing an the thread identification of a thread waiting in a queue,
an assigned processor identification field named AssignedVP (403) for the processor ID of a processor on which the thread is assigned to run,
a lock identification field named LockID (406) for storing the identification of a the lock on which the thread is waiting,
a priority field named Priority (407) for storing the thread's scheduling priority, and
an arrival time field named Arrival_Time (409) for storing the time when the thread arrived in the queue.

Of course many threads may be waiting on the same lock at the same time in the same queue, a fact that is explained in more detail with reference to Table 1.

TABLE 1
Example Wait Queue

| TID | AssignedVP | LockID | Priority | Arrival_Time |
|---|---|---|---|---|
| 43 | 01 | 22 | 1 | 09:23:46.077 |
| 45 | 02 | 22 | 2 | 09:23:46.019 |
| 65 | 03 | 22 | 2 | 09:23:46.063 |
| 98 | 05 | 96 | 1 | 09:23:46.057 |
| 33 | 06 | 96 | 2 | 09:23:46.040 |
| 44 | 06 | 96 | 3 | 09:23:46.003 |

Each entry in Table 1 represents a thread waiting in a wait queue. Each entry contains a thread identification field, an assigned virtual processor field, a lock identification field, a priority field, and an arrival time. The entries in Table 1 represent three threads (TIDs 43, 45, 65) waiting for lock number 22 and three threads (TIDs 98, 33, 44) waiting for lock number 96. In the method of FIG. 4, selecting (401) a thread may be carried out by selecting a thread according to thread priority or according to sequence of thread arrival in a wait queue. Where threads are selected according to thread priority:
when lock number 22 is released, thread 43 is selected, and
when lock number 96 is release, thread 98 is selected.

Where threads are selected according to sequence of thread arrival in a wait queue:
when lock number 22 is released, thread 45 is selected, and
when lock number 96 is release, thread 44 is selected.

The method of FIG. 4 also includes determining (410) whether the assigned virtual processor is running. In the example of FIG. 4, the assigned virtual processor's state is read from a virtual processor control block (416), a data structure representing a virtual processor, in this case the assigned virtual processor, in the hypervisor that contains data elements describing the virtual processor including, for example, its processing priority, its scheduling policy, and, in this example, its processing state, ready, run, wait, and so on. The contents of the virtual processor control block may be made available to an operating system for direct reads, may be made available through hypervisor calls, or may be made available in other ways as will occur to those of skill in the art.

The method of FIG. 4 also includes assigning (418) the thread to run on another virtual processor if the assigned virtual processor is not running (414). Assigning (418) the thread to run on another virtual processor may be carried out by searching through virtual processor control blocks to find a virtual processor in run state and then writing the virtual processor ID of that virtual processor into the AssignedVP field (403) in a data structure representing the selected threads, either a thread control block in the operating system or a data structure like the one at reference (419) on FIG. 4 that represents the thread in a queue.

Awakening the selected thread will include placing (420) the thread in ready state in the ready queue (428) of a logical processor of its newly assigned virtual processor. In ST mode, the new assigned virtual processor will have only one logical processor—two in SMT mode. Note that it is not a limitation of the present invention that the ready queue be empty. That is, the logical processor upon which the selected thread will next run need not be immediately available. It would be an efficiency if it were, but if it is not, then the selected thread will enter the ready queue and compete for possession of the processor with other threads in the ready queue according to the scheduling policies and thread priorities in effect for the queue.

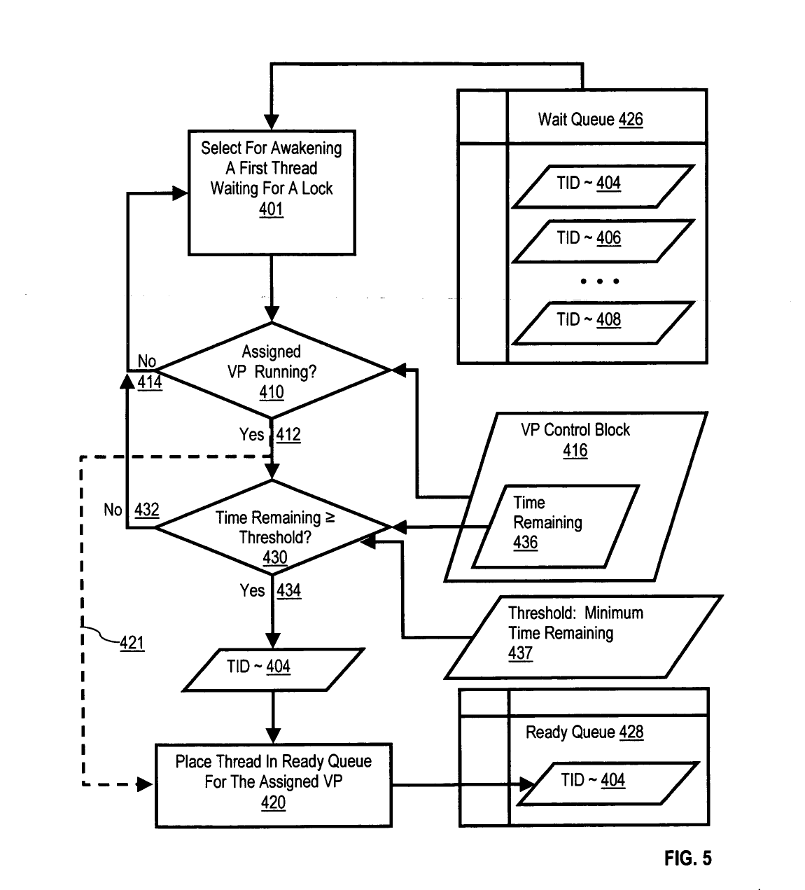

In the method of FIG. 4, when a thread is selected for awakening and its assigned virtual processor is not running, the method then includes finding a virtual processor that is running. It is within the scope of the present invention to increase processing inefficiency generally by selecting for awakening a thread waiting for a lock whose assigned virtual processor is known to be running. For further explanation, therefore, FIG. 5 sets forth a flow chart illustrating a further exemplary method for scheduling threads in a multi-threaded computer according to embodiments of the present invention in which selecting (401) a thread is carried out by selecting a thread having an assigned virtual processor that is running. In the method of FIG. 5, if a selected thread's assigned virtual processor is not running (414), processing continues with selection of another thread (402) until a thread is selected whose assigned virtual processor is running (412). After that, processing may proceed directly (421) to placing (420) the selected thread (404) in a ready queue (428) of its assigned virtual processor.

The purpose of selecting for awakening a thread whose assigned virtual processor is running is to give the selected thread greater opportunity to execute physically, reducing convoy effects by giving the selected thread an opportunity to complete its critical section sooner. This benefit is achieved more affirmatively the earlier it is in the virtual processor's time slice when the thread is assigned to its new virtual processor. The best result of course is that the thread is assigned to its new virtual processor immediately after the virtual processor gains possession of its physical processor—so that the thread may have an opportunity to execute throughout the entire time slice of the virtual processor. Or, if the thread's time slice on the virtual processor is smaller than the virtual processor's time slice on the physical processor, the thread at least may have the opportunity to execute through its entire time slice without delays from virtual processor time outs and virtual processor context switches.

In the method of FIG. 5, selecting a thread may also include selecting a thread having an assigned virtual processor that is running and has at least a predetermined amount of time remaining in its current time slice. In the method of FIG. 5, selecting a thread having an assigned virtual processor with at least a predetermined amount of time remaining in its current time slice is carried out by comparing (430) the time remaining (436) in the virtual processor's current time slice, read from the pertinent virtual processor control block (416) in a hypervisor, with a predetermined threshold (437) configured in the hypervisor as a minimum time remaining in its virtual processor's current time slice below which a thread is not to be selected for awakening. If the time remaining (436) in the virtual processor's time slice is below the threshold (432), another thread is selected (401). If the time remaining (436) in the virtual processor's time slice is equal to or greater than the threshold (434), processing proceeds by placing (420) the selected thread (404) in a ready queue (428) of its assigned virtual processor.

If a virtual processor times out, uses its entire time slice, before a lock-holding thread running on it can complete its critical section, that is, before it can complete the processing for which it acquired the lock, the thread ceases physical execution until the virtual processor returns to run state. The virtual processor loses possession of its physical processor, returning from run state to ready state through a context switch. The virtual processor must again be dispatched through another context switch from the ready queue to its physical processor, subject to the scheduling rules or algorithms in effect for the ready queue in the hypervisor. That is, the virtual processor must again compete with other virtual processors in the ready queue just like any other virtual processor in the ready queue. In terms of overall system performance, such a procedure, involving as it does at least two virtual processor context switches with one or more other time slices in between in which at least one other virtual processor runs, is slow. It would be advantageous if the likelihood could be improved that the thread holding the lock will complete its critical section during its virtual processor's current time slice. One way to increase that likelihood is to increase the size of the virtual processor's time slice.

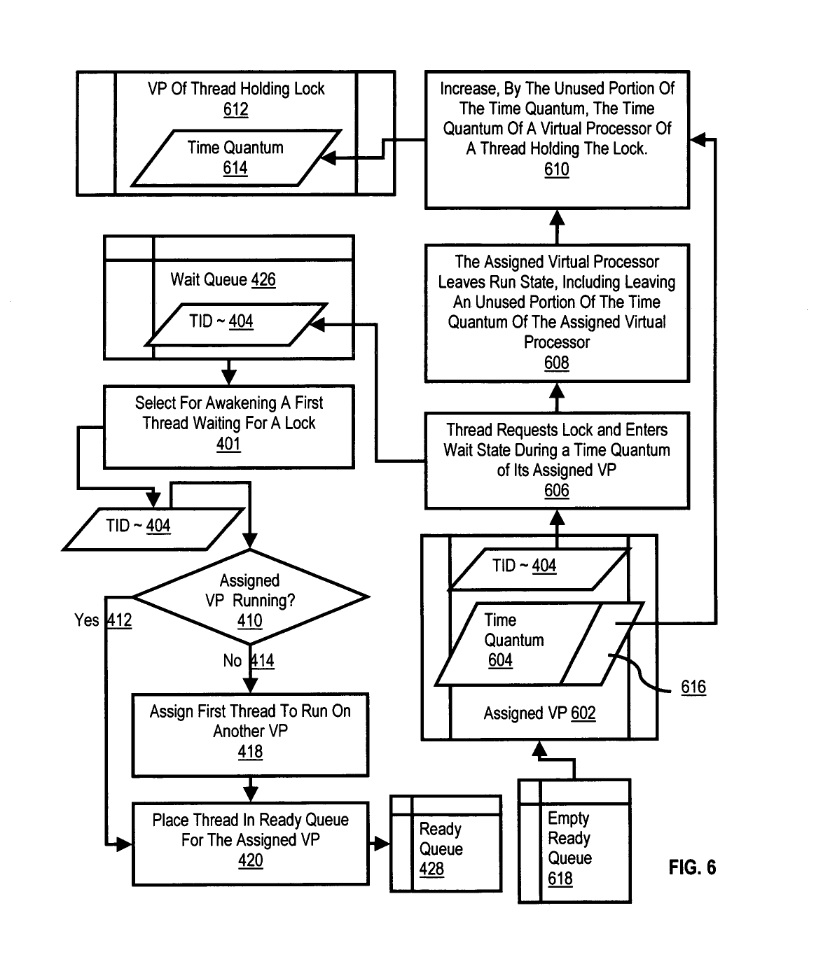

For further explanation, FIG. 6 sets forth a flow chart illustrating a further exemplary method for scheduling threads in a multi-threaded computer according to embodiments of the present invention that increases the size of the time slice of a virtual processor upon which a lock-holding thread is running. The method of FIG. 6 includes selecting (401) for awakening a thread (404) that is waiting for a lock, determining (410) whether the assigned virtual processor is running, assigning (418) the thread to run on another virtual processor if the assigned virtual processor is not running (414), and so on as described above. The method of FIG. 6 also includes the thread's requesting (606) a lock and entering wait state during a time quantum (604) of the assigned virtual processor (602). In the example of FIG. 6, the assigned virtual processor has no threads in ready state (618). The method of FIG. 6 also includes the assigned virtual processor's leaving (608) run state, leaving an unused portion (616) of the time quantum (604) of the assigned virtual processor (602). The method of FIG. 6 also includes increasing (610), by the unused portion (616) of the time quantum (604) of the assigned virtual processor (602), the time quantum (614) of a virtual processor (612) of a thread holding the lock.

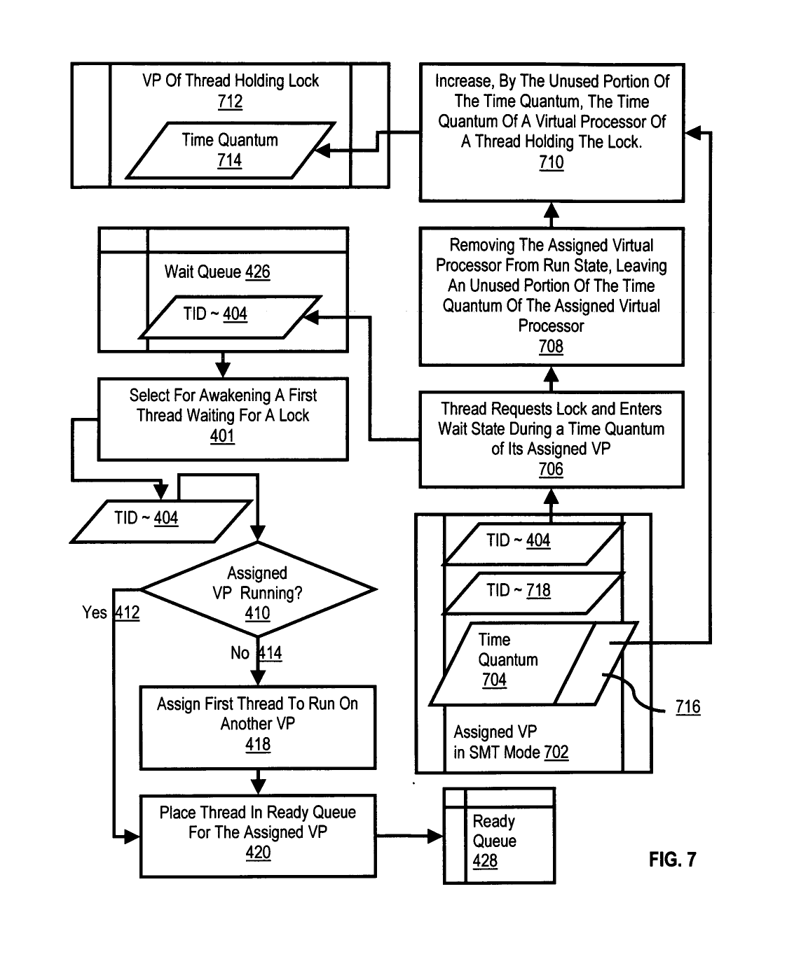

For further explanation, FIG. 7 sets forth a flow chart illustrating a further exemplary method for scheduling threads in a multi-threaded computer according to embodiments of the present invention that increases the size of the time slice of a virtual processor upon which a lock-holding thread is running. The method of FIG. 7 includes selecting (401) for awakening a thread (404) that is waiting for a lock, determining (410) whether the assigned virtual processor is running, assigning (418) the thread to run on another virtual processor if the assigned virtual processor is not running (414), and so on as described above. In the method of FIG. 7, the assigned virtual processor (702) is running in SMT mode with two active SMT threads including the thread (404) and a second thread (718). Ordinarily the virtual processor of the lock-holding thread would only leave the run state, relinquishing the physical processor and giving up the remainder of its time slice, when both threads have voluntarily given up control, that is, when each SMT thread (or logical processor) has exited all threads running on it and there are no threads in ready state for either logical processor.

In this example, however, the hypervisor is programmed to forcibly remove the assigned virtual processor from run state, regardless whether the second thread is still running and regardless whether the assigned virtual processor has threads in ready state. This again leaves an unused portion of a time quantum of the assigned virtual processor. The hypervisor is programmed to then add the unused portion of the time quantum of the assigned virtual processor to the time quantum of the virtual processor holding the lock. Thus the method of FIG. 7 includes the thread's requesting (706) a lock and entering wait state during a time quantum (704) of the assigned virtual processor. The method of FIG. 7 also includes removing (708) the assigned virtual processor from run state, regardless whether the second thread is still running and regardless whether the assigned virtual processor has threads in ready state. In this example, the assigned virtual processor is forcibly removed from run state by a hypervisor programmed to do so, and its removal leaves an unused portion (716) of a time quantum (704) of the assigned virtual processor (702). And the method of FIG. 7 also includes increasing (710) the time quantum (714) of a virtual processor (712) of a thread holding the lock by the unused portion (716) of the time quantum (704) of the assigned virtual processor (702).

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method for scheduling threads in a multi-threaded computer, the method comprising:
selecting for awakening a thread that is waiting for a lock, the thread having an assigned virtual processor;
determining whether the assigned virtual processor is running; and
if the assigned virtual processor is not running, assigning the thread to run on another virtual processor.

2. The method of claim 1 wherein selecting the thread further comprises selecting the thread according to thread priority.

3. The method of claim 1 wherein selecting the thread further comprises selecting the thread according to sequence of thread arrival in a wait queue.

4. The method of claim 1 wherein selecting a thread further comprises selecting a thread having an assigned virtual processor that is running.

5. The method of claim 1 wherein selecting a thread further comprises selecting a thread having an assigned virtual processor that is running and has at least a predetermined amount of time remaining in its current time slice.

6. The method of claim 1 further comprising:
the thread's requesting a lock and entering wait state during a time quantum of the assigned virtual processor wherein the assigned virtual processor has no threads in ready state;
the assigned virtual processor's leaving run state, including leaving an unused portion of the time quantum of the assigned virtual processor; and
increasing, by the unused portion of the time quantum of the assigned virtual processor, the time quantum of a virtual processor of a thread holding the lock.

7. The method of claim 1 wherein the assigned virtual processor is running in simultaneous multi-threading (‘SMT’) mode with two active SMT threads including the thread and a second thread and the method further comprises:
the thread's requesting a lock and entering wait state during a time quantum of the assigned virtual processor;
removing the assigned virtual processor from run state, regardless whether the second thread is still running and regardless whether the assigned virtual processor has threads in ready state, including leaving an unused portion of a time quantum of the assigned virtual processor; and
increasing the time quantum of a virtual processor of a thread holding the lock by the unused portion of the time quantum of the assigned virtual processor.

8. A system for scheduling threads in a multi-threaded computer, the system comprising:
means for selecting for awakening a thread that is waiting for a lock, the thread having an assigned virtual processor;
means for determining whether the assigned virtual processor is running; and
means for assigning the thread to run on another virtual processor if the assigned virtual processor is not running.

9. The system of claim 8 wherein means for selecting the thread further comprises means for selecting the thread according to sequence of thread arrival in a wait queue.

10. The system of claim 8 wherein means for selecting a thread further comprises means for selecting a thread having an assigned virtual processor that is running.

11. The system of claim 8 wherein means for selecting a thread further comprises means for selecting a thread having an assigned virtual processor that is running and has at least a predetermined amount of time remaining in its current time slice.

12. The system of claim 8 further comprising:
means for the a thread to request a lock and enter wait state during a time quantum of the assigned virtual processor when the assigned virtual processor has no threads in ready state;
means for the assigned virtual processor to leave run state, including means for leaving an unused portion of the time quantum of the assigned virtual processor; and
means for increasing, by the unused portion of the time quantum of the assigned virtual processor, the time quantum of a virtual processor of a thread holding the lock.

13. The system of claim 8 wherein the assigned virtual processor runs in simultaneous multi-threading (‘SMT’) mode with two active SMT threads including the thread and a second thread, and the system further comprises:
means for the thread to request a lock and enter wait state during a time quantum of the assigned virtual processor;
means for removing the assigned virtual processor from run state, regardless whether the second thread is still running and regardless whether the assigned virtual processor has threads in ready state, including means for leaving an unused portion of a time quantum of the assigned virtual processor; and
means for increasing the time quantum of a virtual processor of a thread holding the lock by the unused portion of the time quantum of the assigned virtual processor.

14. A computer program product for scheduling threads in a multi-threaded computer, the computer program product comprising:
a recording medium;
means, recorded on the recording medium, for selecting for awakening a thread that is waiting for a lock, the thread having an assigned virtual processor;
means, recorded on the recording medium, for determining whether the assigned virtual processor is running; and
means, recorded on the recording medium, for assigning the thread to run on another virtual processor if the assigned virtual processor is not running.

15. The computer program product of claim 14 wherein means, recorded on the recording medium, for selecting the thread further comprises means, recorded on the recording medium, for selecting the thread according to thread priority.

16. The computer program product of claim 14 wherein means, recorded on the recording medium, for selecting the thread further comprises means, recorded on the recording medium, for selecting the thread according to sequence of thread arrival in a wait queue.

17. The computer program product of claim 14 wherein means, recorded on the recording medium, for selecting a thread further comprises means, recorded on the recording medium, for selecting a thread having an assigned virtual processor that is running.

18. The computer program product of claim 14 wherein means, recorded on the recording medium, for selecting a thread further comprises means, recorded on the recording medium, for selecting a thread having an assigned virtual processor that is running and has at least a predetermined amount of time remaining in its current time slice.

19. The computer program product of claim 14 further comprising:
means, recorded on the recording medium, for the a thread to request a lock and enter wait state during a time quantum of the assigned virtual processor when the assigned virtual processor has no threads in ready state;
means, recorded on the recording medium, for the assigned virtual processor to leave run state, including means, recorded on the recording medium, for leaving an unused portion of the time quantum of the assigned virtual processor; and
means, recorded on the recording medium, for increasing, by the unused portion of the time quantum of the assigned virtual processor, the time quantum of a virtual processor of a thread holding the lock.

20. The computer program product of claim 14 wherein the assigned virtual processor runs in simultaneous multi-threading (‘SMT’) mode with two active SMT threads including the thread and a second thread, and the computer program product further comprises:
means, recorded on the recording medium, for the thread to request a lock and enter wait state during a time quantum of the assigned virtual processor;
means, recorded on the recording medium, for removing the assigned virtual processor from run state, regardless whether the second thread is still running and regardless whether the assigned virtual processor has threads in ready state, including means, recorded on the recording medium, for leaving an unused portion of a time quantum of the assigned virtual processor; and
means, recorded on the recording medium, for increasing the time quantum of a virtual processor of a thread holding the lock by the unused portion of the time quantum of the assigned virtual processor.
